(19) United States
(12) Patent Application Publication
(10) Pub. No.: US 2002/0109314 A1
(43) Pub. Date: Aug. 15, 2002

(54) Roller-blade scooter

(76) Inventor: Ting-Hsing Chen, Tainan Hsien (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 09/783,071

(22) Filed: Feb. 15, 2001

(51) Int. Cl. B62B 13/00; B62B 15/00; B62B 17/00

(52) U.S. Cl. 280/14.28

(57) ABSTRACT

A roller-blade scooter comprises a pair of blades secured to the front steering device and the rear frame of the scooter. A brake device is mounted to the rear frame which is formed with teeth at the bottom end, that will engage with the ice on the ground. An elastic member is attached to the brake device to provide a restoring force.

### BACKGROUND OF THE INVENTION

1. Field of the Invention

This invention relates to a roller-blade scooter, and more particularly to a pair of blades with one secured to the bottom of a front steering device and the other to a rear frame of a scooter for skating on ice.

2. Description of Prior Art

A conventional scooter is mostly used to roll with wheels on a ground, which is not only an exercise and fin to the users but also a convenient transportation. However, this design is useful on outdoor and indoor ground but it can not be used on ice, thus people living in the area where snow is often occurred.

In view of this, the inventor has invented the present invention, which may roll on an icy floor or ground.

### SUMMARY OF THE INVENTION

It is the primary object of the present invention to provide a roller blade scooter, which is able to skate on icy ground.

It is another object of the present invention to provide a roller blade scooter, which is safe and has a great stability.

It is a further object of the present invention to provide a roller blade scooter, which is easy to mount and inexpensive in manufacture.

### BRIEF DESCRIPTION OF THE DRAWINGS

FIG. 1 is an exploded view of a roller blade scooter of the present invention;

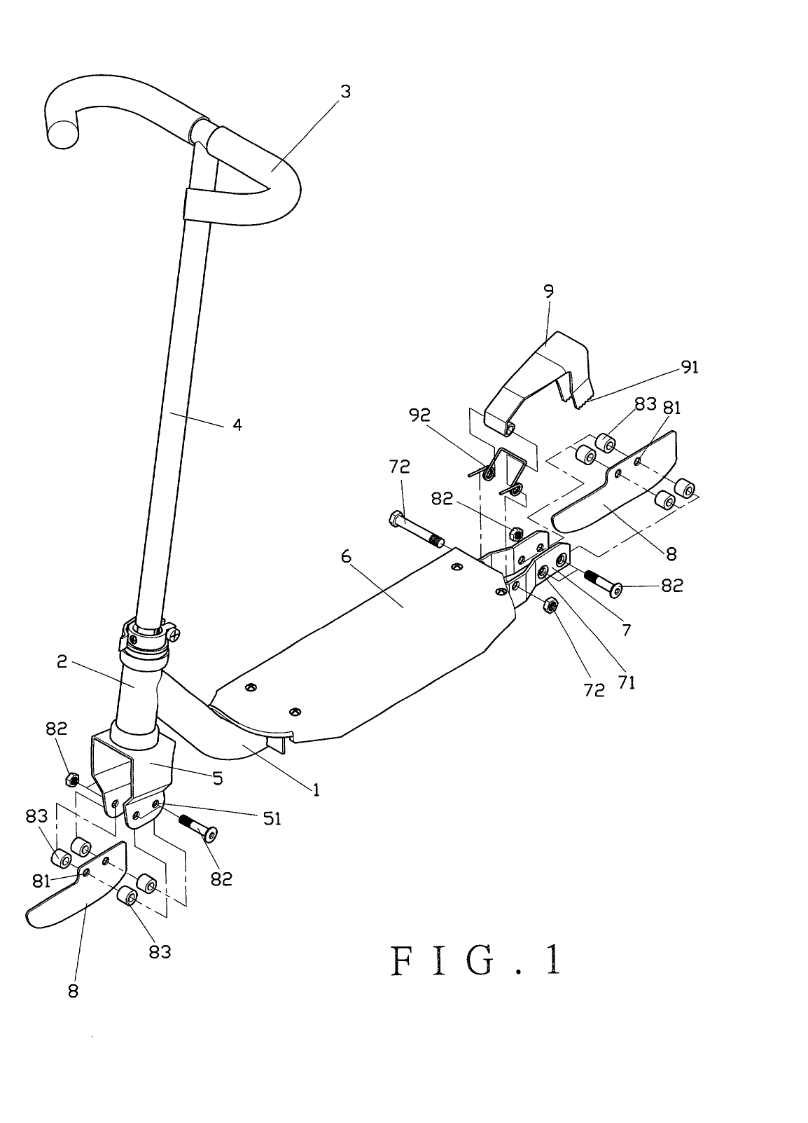

FIG. 2 is a perspective view of the present invention;

FIG. 3 is a side view of the present invention;

FIG. 4 is a view similar to FIG. 3 showing a braking status;

FIG. 5 is an enlarged view of another brake mechanism of the present invention; and

FIG. 6 is an enlarged view similar to FIG. 5 showing a braking status.

### DETAILED DESCRIPTION OF THE PREFERRED EMBODIMENT

The roller blade scooter is generally composed of a frame having a front strut 2, a handle stick 4, a handle 3 and a front steering device 5 connected to the front end of the frame 1 in sequence, a board 6 secured on the middle portion of the frame 1, and a rear frame 7 secured to the rear end of the frame 1.

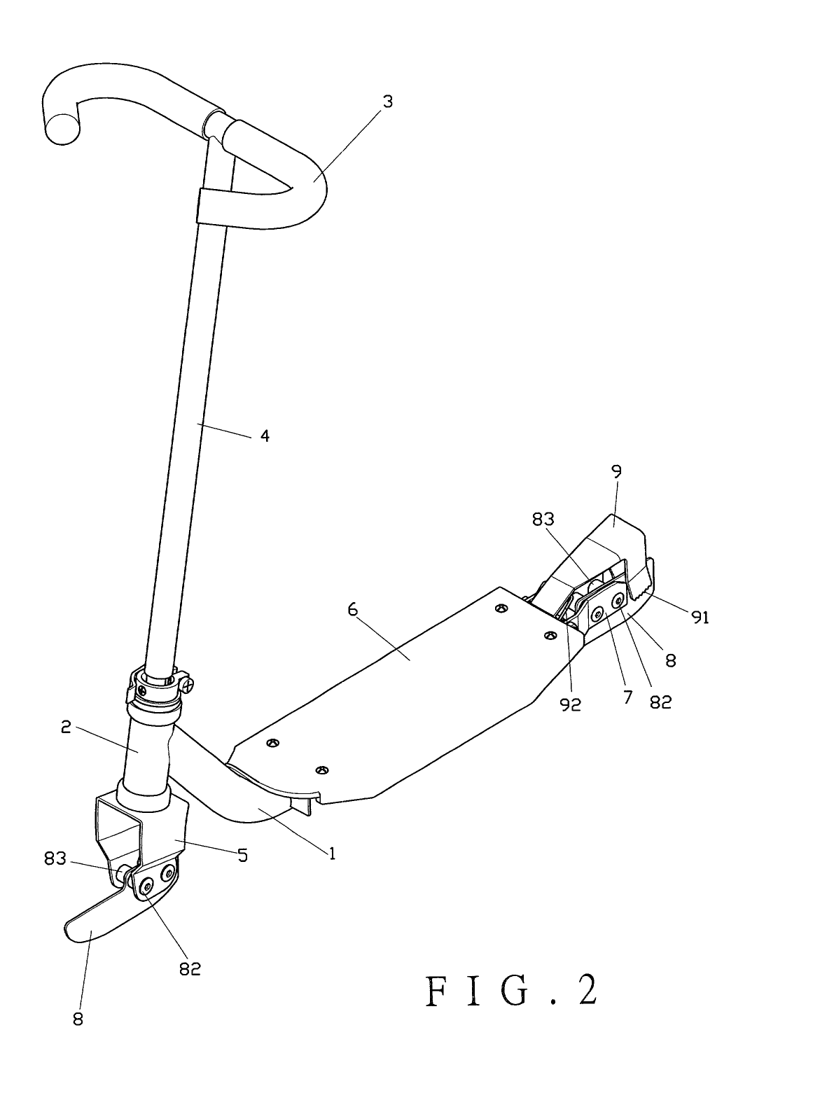

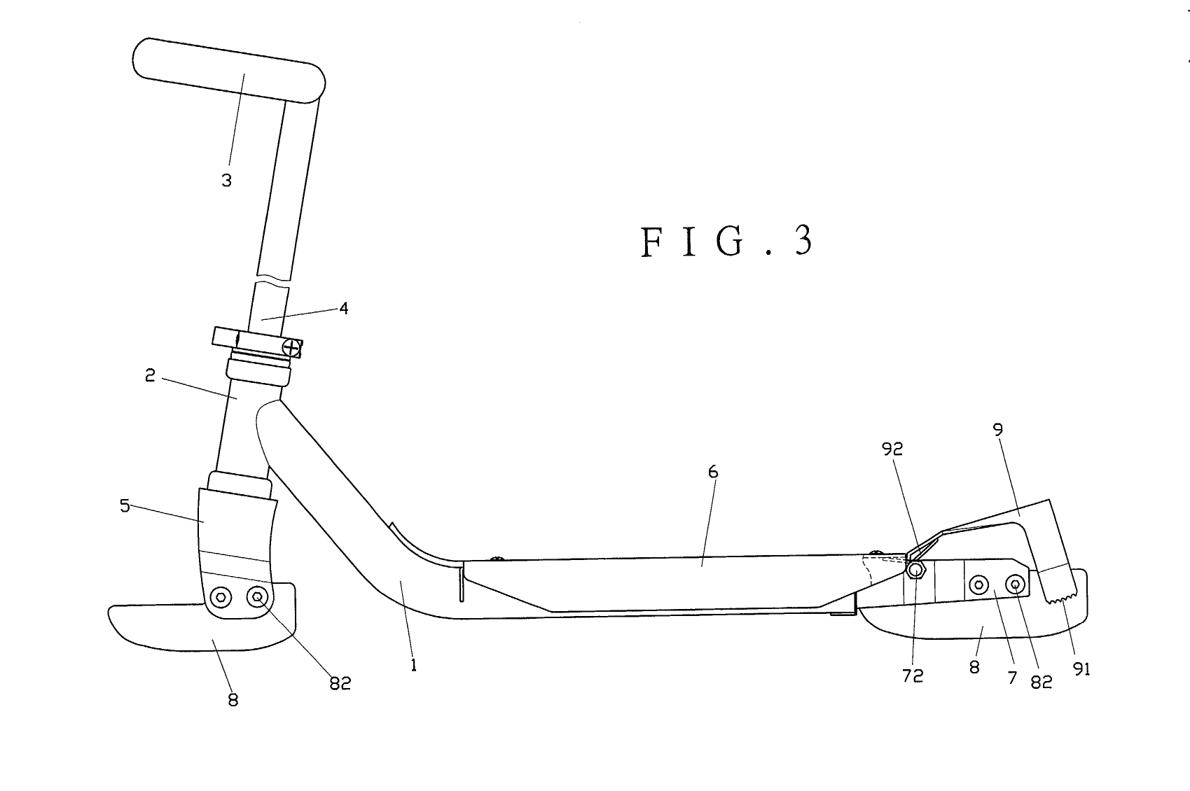

The front steering device 5 and the rear frame 7, as shown in FIGS. 2, 3 and 4, are secured with a blade 8 thereat, respectively. Each blade 8 comprises holes 81 which correspond to holes 51 of the front steering device 5 and holes 71 of the rear frame 7, so that the blades 8 may be secured to the front steering device 5 and the rear frame 7 by means of fasteners 82.

A brake device 9 is secured to the rear frame 7 by means of a fastener 72. The brake device 9 comprises teeth 91 at its bottom end. The teeth 91 are used to stop the scooter from movement when engaging with the icy ground. The brake device 9 has an elastic member 92 which provides the teeth 91 a restoring force after brake.

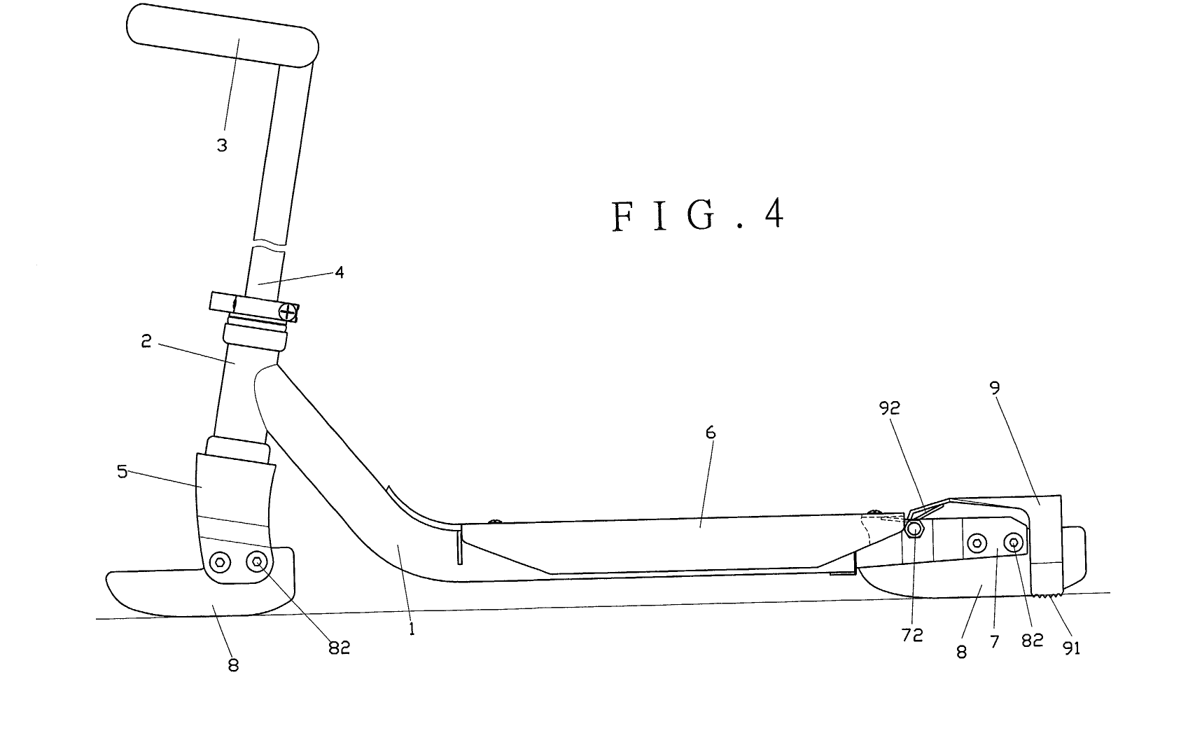

FIG. 4 shows the present invention in a braking status, the scooter is down by stepping the elastic member 92 which forces the teeth 91 to drop and engage with the icy ground, that produces a friction to stop the movement of the scooter.

An other design may be used without deviating from the principle of this invention, such as to form the blades which are integral to the front steering device 5 or to the rear frame 7.

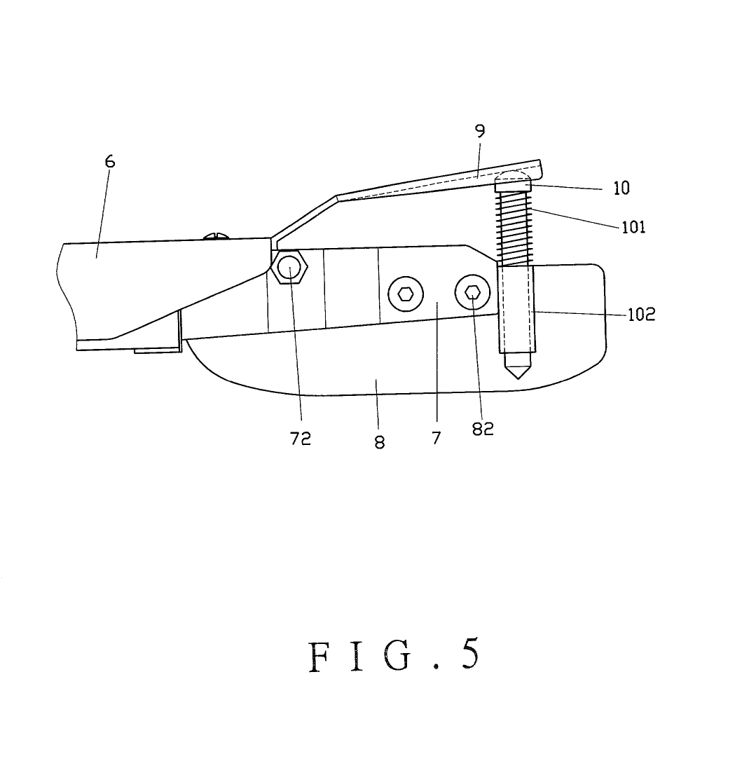

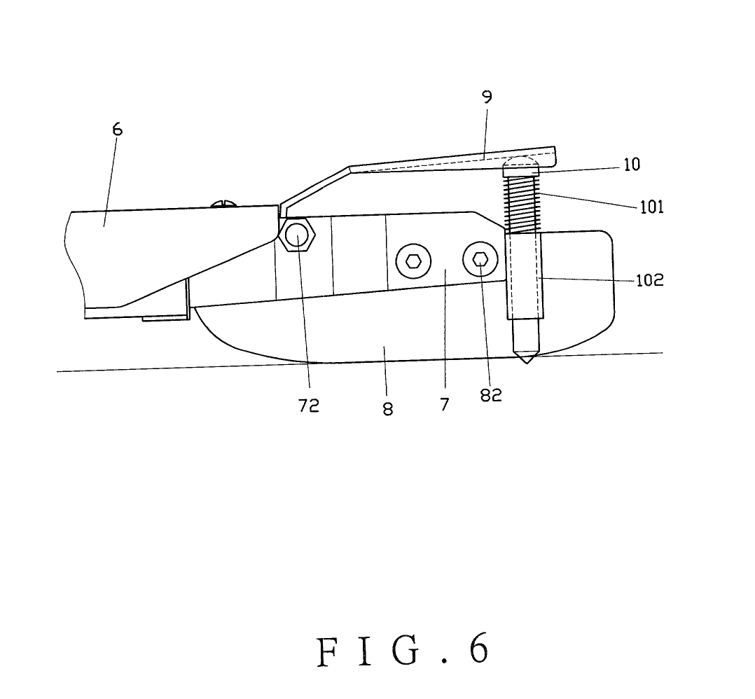

Another design is formed by replacing the teeth 91 with a brake shaft 10 at one side of the blade 8 secured to the rear frame 7. The brake shaft 10 is inserted through a spring 101 and into a sleeve 102 of the blade 8, as shown in FIG. 5. The top end of the brake shaft 10 is in touching with the bottom end of the brake device 9, thus by pressing the brake device 9, as shown in FIG. 6, the brake shaft 10 extends downwards and engages with the icy ground.

I claim:

1. A roller blade scooter comprising a front strut with a handle stick, a handle and a front steering device connected to a front end of a frame, a board at middle portion and a rear frame at opposing end thereof, and the improvements comprising
said front steering device and said rear frame being secured with a blade, respectively.

2. The roller blade scooter, as recited in claim 1, wherein said rear frame has a brake device secured thereat.

3. The roller blade scooter, as recited in claim 2, wherein said brake device is formed with teeth at a bottom end thereof.

4. The roller blade scooter, as recited in claim 2, wherein said brake device comprises an elastic member which provides an urging force to restore said teeth when said brake device being pushed down and engaging with the icy ground.

5. The roller blade scooter, as recited in claim 3, wherein said brake device comprises an elastic member which provides an urging force to restore said teeth when said brake device being pushed down and engaging with the icy ground.

6. The roller blade scooter, as recited in claim 1, wherein said blades is formed integrally to said front steering device and said rear frame of said scooter.

7. The roller blade scooter, as recited in claim 1, wherein said blade comprises a brake shaft at one side of said blade, the brake shaft is inserted through a spring and into a sleeve of said blade, the top end of said brake shaft is in touching with the bottom end of said brake device.

8. The roller blade scooter, as recited in claim 2, wherein said blade comprises a brake shaft at one side of said blade, the brake shaft is inserted through a spring and into a sleeve of said blade, the top end of said brake shaft is in touching with the bottom end of said brake device.
